(19) United States
(12) Patent Application Publication
(10) Pub. No.: US 2025/0073764 A1
(43) Pub. Date: Mar. 6, 2025

(54) METHOD OF ACCELERATED BIODEGRADATION OF TOXIC, ORGANIC CHEMICALS

(71) Applicant: LIVSKVALITET APS, Nykøbing Sj (DK)

(72) Inventor: Sören VENTEGODT, Vanløse (DK)

(21) Appl. No.: 18/726,589

(22) PCT Filed: Jan. 25, 2023
(86) PCT No.: PCT/EP2023/051767

§ 371 Date: Jul. 3, 2024

(30) Foreign Application Priority Data
Jan. 26, 2022 (SE) 2250071-4

(51) Int. Cl. B09C 1/10

(52) U.S. Cl. CPC B09C 1/10; B09C 1/105; B09C 2101/00

(57) ABSTRACT

A method for treating soil in situ or ex situ to reduce the concentration of contaminating or polluting organic chemical compounds is provided. The method comprises steps of: a) determining a contaminated/polluted area where soil is to be treated; b) adding a fertilizer in the form of warm-composted manure or other compost having a nutrient content corresponding to warm composted manure and in which the nutrients are correspondingly hard bound to the compost to a soil layer in the area, the fertilizer being added in an amount of 10% (weight percentage) or more of soil of the soil layer; c) adding iron, unless the soil of the soil layer already comprises at least 2 kg of iron per ton of soil; d) adjusting soil pH to an acidic pH; and e) keeping the soil of the soil layer moist by adding water as needed for a predetermined period.

### SUMMARY OF THE INVENTION

This invention is a general method of accelerated biodegradation/bioremediation (also called biostimulation) of all types of organic molecules considered contaminants or pollutants in soil, in situ, or ex situ. The method uses the existing scientific knowledge on acceleration of biodegradation/bioremediation gained from laboratory studies. The most important part of the method is mixing 10% or more nutrition-rich organic material (preferably a fertilizer like warm-composted manure) into the top-soil, together with iron and a pH-regulator, to make the soil acidic, or basic when this is needed.

The treated soil must be kept wet while the process is going. The soil is preferably covered with an organic material that holds on to the water, allows ventilation, and attracts earthworms.

Biodegradation is fast, effective, cheap and sustainable, and the new method furthermore improves the quality of the soil, and is compatible with organic farming.

### DETAILED DESCRIPTION

The present invention relates to a method for fast, effective, affordable, and sustainable clearing of pollution with DDT and other toxic, organic molecules in soil, directly in situ on farmland, or ex situ, i.e. elsewhere. The method can also be used for muds i.e. sludge and liquids. A new method for accelerated biodegradation, also called bioremediation or biostimulation, of unwanted or toxic organic compounds—contaminants or pollutants—in situ or elsewhere is presented. The method uses a combination of a number of important factors discovered by research in biodegradation during the last decades. Organic molecules are present everywhere as contaminants, and often in toxic concentration, as pollutants. The world's contaminated/polluted areas are so vast, that it seems impossible to clear the land. An important example of this is the global pollution with DDT and other organic pesticides, that have been spread in hundreds of millions of tons on millions of hectares of farmland, nurseries, gardens etc., and still remain there in high concentrations—50 years after they were banned.

Biodegradation is fast, effective, cheap and sustainable Biodegradation is fast, effective, cheap and sustainable, and compatible with organic farming; the new method we introduce furthermore improves the quality of the soil. The half-life of toxic molecules is taken down from decades (20-30 years for DDT) to a year or less.

### The Important Factors

The factors found to be important for biodegradation are: a high content of nutrition-rich substrate (10% weight percent or more), water, oxygen, iron, earthworms, and low pH. These factors must all be carefully regulated.

The steps are the following:

1) Measure the concentration of the contaminant(s)/pollutant(s) in appropriate depths, and compare to the relevant threshold value(s). 2) Estimate the area you can process from the availability of fertilizer like warm-composted manure and the legal limit for its use. 3) Decide the thickness of the top layer you want to treat (i.e. 8-12 cm). 4) Mix the fertilizer in the designated area, after adding 2 kg iron, and regulating the pH, preferably to pH=4.5-5.5, or 2.0-4.0 or 7.0-9.0 when this is needed. 5) Cover the area to be treated with a 1-20 cm thick layer comprising organic material, preferably 3-6 cm thick layer of organic material, which keeps the soil moist and attracts earthworms. 6) Water the treated spot for the next 12 months. 7) Measure the pollution again, and repeat on the same, or a deeper soil layer, if necessary.

### The Compost Used

The organic substrate used for the process must release its nutrients slowly. We use warm-composted manure with bedding of straw or wood chips from chicken, cow or horse, but any compost with a high content of nutrients (N, P, K, and micronutrients) can be used. We use “spot treatment” of the most polluted areas, combined with gradually going deeper into the soil, thus “planning” of the polluted ground, to get the concentration of the pollutants down to the acceptable level.

### Applicability of the Method

The presented method degrades all organic molecules and is especially useful for degrading natural or synthetic, toxic, organic compounds, i.e. polycyclic aromatic hydrocarbons (PAHs), organochlorine insecticides, organophosphate and carbamate insecticides, organic herbicides, and dioxin contaminant of herbicides and wood preservatives. Small organic, toxic molecules like dioxins can also be processed. The broad applicability allowing for cleaning the soil of even unknown organic substances, makes the presented method unique.

The chemicals that can be biodegraded are in principle any simple or complicated compound. But of special interest are pesticides such as one or more of the substances DDT, DDD DDE and/or DDTr and compounds from the petrochemical industry like gasoline, oil and other polycyclic and aromatic substances.

### Adding Phytoremediation and Bioaugmentation

The effectivity and applicability of the presented method can further be increased by combining it with other methods, like phytoremediation (using plants), and bioaugmentation (adding specific bacteria, fungi etc.).

### Good for Organic Farming

The presented method is compatible with organic farming and improves the soil quality.

### General Applicability

The presented method can be used to accelerate biodegradation of organic molecules in general; in solids like soil, clay, sand, in muds (i.e. sludge), or in water.

The method can also be used when the treated substance is not a solid substance but a sludge or a polluted liquid, that is mixed with manure/compost/fertilizer/bacterial nutrients, and given the addition of iron and the adjustment of the pH. The polluted material is added to fresh manure before or while the manure is being warm-composted whereby the reduction of the concentration of contaminating or polluting organic chemical compounds in the polluted sludge or liquid takes place in solid phase. The resulting compost can then be used as normal compost or for further biodegradation. The polluted sludge or liquid can also be added to a biogas facility, willow cleaning facility or similar system. A biogas plant can thus be used for cleaning a contaminant or pollutant out of the polluted liquid. For example: This method can be used in phyto-cleaning facilities, i.e. willow cleaning facilities, where the biodegradation happens in the sludge, when the accumulated sludge is added iron and pH-regulated. In this situation the sludge functions as its own compost.

Millions of field and land sites are today contaminated or polluted with organic chemicals that have a long half-life and therefore stay in the soil, sometimes for many decades.

In Europe there are 250,000 polluted fields today, and 295,000 in the USA. Wherever you look for it, you find polluted land, so polluted that using it puts people in danger.

One of the most troublesome pesticides that have been used almost globally and in excessive amounts, before its toxic properties were discovered and the compound banned is DDT. DDT was selected for its enormous chemical stability—no energy can come from breaking this compound down. Combined with its strong anti-estrogenic effects affecting almost the whole animal kingdom, DDT pollution has been an enormous challenge and thousands of research papers exist on biodegradation of DDT in the lab and in situ.

The large body of research on DDT contains knowledge on how to break down not only DDT but organic molecules in general, even the most toxic and the most stable. The invention we present here is primarily based on research in biodegradation of DDT in the lab, but has general applicability.

DDT (1,1,1-trichloro-2,2-bis(p-chlorophenyl)ethane, traditionally dichlorodiphenyltrichloroethane) is one of the most effective, synthetic insecticides. Made available around 1940, DDT was used on a big scale as an agricultural insecticide. It is nearly insoluble in water but has a good solubility in most organic solvents, fats and oils.

Commercial DDT is a mixture of several related compounds (DDTr). It has a significant amount of (15%) dichloro-diphenyl-dichloro-ethylene (DDE) and dichloro-diphenyl-dichloroethane (DDD). Isomers of DDD and DDE are as toxic as DDT, and as resilient. The research has documented that if a method works on DDT, it also works on all the related molecules, hence the general applicability.

Since DDTr are lipophilic they tend to accumulate in the fatty tissues of the ingesting organism along the food chain. It is reported to be a potent, endocrine disruptor in both avians and mammals. DDTr poisoning is resulting in egg shell thinning in birds, impaired male and female reproductive ability in humans, and much more, as it interferes with all the animal and human tissues sensitive to sex hormones; it furthermore causes cancer and many nervous diseases.

Many experiments have tried to take DDT out of the soil in mechanical processes; one effective method is to burn the soil; another to use ozone (O3. To treat all the soil of a field in a mechanical system (a reaction chamber) with Ozone or other chemicals is very expensive, and not realistic for the normal farmer, who wants to take DDT out of his fields.

Biodegradation however seems most effective. Biodegradation is the process by which organic substances are broken down by the enzymes produced by living organisms. The process works on all simple and complex organic molecules, and luckily also on toxic chloro-organic molecules like DDT.

In the most promising recent experiments, the half-life of DDT, DDE and DDE are found to go down from 20-30 years in the soil to a few weeks. If this degradation speed could be copied in a general procedure applicable for clearing DDT pollution from farmland, like old vegetable fields and apple orchards, this could be of major importance for the world, so this is where our research started.

We soon discovered, that it was evident that many micro-organisms have the astonishing, naturally occurring, microbial catabolic diversity to degrade or transform hydrocarbons (e.g. oil), polychlorinated biphenyls (PCBs), and poly aromatic hydrocarbons (PAHS).

Amongst the known micro-organisms capable to degrade even DDT we find:

### Bacteria:

Escherichia coli
Enterobacter aerogens
Enterobacter cloacae
Klebsiella pneumonia
Pseudomonas aeruginosa
Pseudomonas putida
Bacillus species
Hydrogenomonas

### Fungi:

Saccharomyces cervisiae
Phanerochaete chrysosporium
Trichoderma viridae

Many of these organisms are common in soil and in horse-, cow- and chicken manure. DDTr is metabolized through co-metabolism pathway by a great number of facultative and obligate micro-organisms under suitable conditions.

Studies have clearly shown that there is a wide variety of micro-organisms, both bacteria and fungi, in the normal soil that can degrade complicated organic molecules, even if these cannot be used as a nutrient, like DDTr. The rate of bio-degradation is dependent both on the concentration of the microorganisms and the substrate, and on the biodiversity in the soil, i.e. numbers of different microbes in the soil.

The result of a lab experiment, where bacteria was added to a soil containing DDT was, that after only 25 days a significant amount of the DDT (30-50%) was degraded by one bacteria; but more importantly it was found that a combination of different bacteria dramatically accelerated the process, giving a half-life of only 13 days (here 83% of DDT was degraded). The logical consequence of this finding is that instead of cultivating a single, specific bacteria (as it is done in bioaugmentation), one should find and add a growth media to the soil, where large amounts of many different bacteria are already present.

In other experiments the fungal, eco-friendly enzyme laccase was found effective in degrading DDT with a half-life of about 100 days. Unfortunately, the enzyme itself is so costly and must be used in so large quantities, that this is not a realistic method in farming. Therefore, the discovery of this interesting chemical process did not lead to a successful, commercial solution.

A discovery that we find of great practical importance was done in 2010, where it was found that fertilizers with iron dramatically accelerated the biodegradation of complicated organic molecules like DDT. It was found that the substrate must be rich in iron, and the optimal biodegradation seems to happen with 1.9 kg of iron (metallic powder, Fe2+ or Fe3+, with Fe2+ as the preferred form) per ton of added fertilizer.

Another study showed that the soil should not be so wet that it stops the diffusion of oxygen into it (9).

A similar pattern was observed in the remediation of DDT contaminated soil by laccase under different flooding conditions: the higher the concentrations of oxygen in soil, the lower the residues of DDT components and DDTrs in soils. The residue of DDTs in the non-flooding soil declined by 16.7% compared to the flooded soil at the end of the incubation. The residues of DDTs in soils treated with laccase were lower in the pH range 2.5-4.5. We here see an example of the importance of a low pH for the degradation process for many degrading enzymes.

A way to get more oxygen into the soil is using a surfactant. This method works in a lab but seems unrealistic in common farm practice for economic reasons. The effectiveness of surfactant in lab experiments does underline the necessity of a good air flow for the biodegradation process, explaining the many positive findings of accelerated biodegradation related to the presence and high concentration of earthworms, known for effectively draining and ventilating the soil.

The research, motivated by commercial interests, has mostly been a search for the “wonder bacterium” that could be sold to farmers and spread on the soil to remove DDT. No such wonder-bacterium has yet been found—nor has a wonder-chemical, like a magical surfactant giving more oxygen to the soil in situ, been identified.

The major laboratory experiments with biodegradation have shown the possibility of extremely rapid degradation of DDT and similar stabile molecules using a combination of multiple naturally occurring organisms under optimal condition; while a few weeks might be very optimistic in situ—a half-life of three weeks or so are often found in the lab, and half-lives down to 11 days have been seen.

What seems effective in the field is the combination of a long row of micro-organisms, both bacteria and fungi, that seem to cooperate in complicated ways in the processing of the organic material in the soil, and in degrading organic molecules, including large, stabile, “annoying” membrane-seeking lipophilic organic, molecules like DDT, DDE and DDD.

Studies have also shown that the rate of biodegradation of organic molecules like DDT and its derivatives are strongly dependent on earthworms, maybe even proportional to the number of earthworms in the soil. Therefore, anything that increases the number of worms, like dead leaves and other organic material, like compost or manure the worms like, will accelerate the degradation speed significantly.

A number of implementation experiments are ongoing and have already suggested that worms, bacteria and fungi must be supported, and a good organic substrate for this seems to be warm-composted manure added to the fields in substantial amount; of course adding a top layer of tree leaves or similar organic material the worms like as food will also contribute to the soils content of worms, which is therefore recommended.

Interestingly, a composting method was patented 1997, which was based on mixing vast amounts of manure into the soil. The method seemed to work—and work well. A minus here was that the protocol for the procedure was highly complicated, and somewhat irrational, making the procedure both time- and work-consuming. The long row of unnecessarily complicated steps, that was repeated again and again, made the method little used, and it is not well known or much used today. But the project was definitely a big step in the right direction, strongly indicating that there is a simple, good solution to the problem of pollution with organic chemicals like DDT; we just have to find it.

Other studies have shown that if biodegradation processes run around 60° C., molecules like DDT can be broken down in a matter of days. But this temperature is of course not realistic in a field. Similar results were found in studies where the pH was extremely low, around 2-3; again such a pH is incompatible with worms that often die in a pH under 4.5; and therefore such a low pH is not realistic in living soil.

Another series of biodegradation studies were done with chicken manure; where it was found as well that a high concentration of water accelerates the biodegradation process. The research team also found that the concentration of the degradation products gradually increased when they gradually increased the amount of chicken manure added. The conclusion was again, that the more manure and the more water added, the better the biodegradation. This experiment was made with clay soil.

Many experiments have found the soil type to be important. Several of the above mentioned experiments were done with tropical soil, which is different from the soil i.e. in the Nordic countries, but there is no reason to believe that the tested processes would work differently in Nordic soil.

The research of the last two decades has thus given us the necessary factors we need to take into consideration, when we want organic molecules—also the hard-to break molecules like DDTr—to be taken out of the soil with an accelerated biodegradation (bioremediation, biostimulation).

Today we have sufficient knowledge to bring down the half-time of chemicals like DDTr—also when they are hardly bound in the soil-from 20-30 years to a number of months. There can still be local factors impossible to control, i.e. local flooding, high pH from chalk, scarcity of earth worms etc. that slow the process down so it takes years. With this said, the process will in general accelerate the biodegradation process so the half-life of molecules like DDTr reduces from 20-30 years to a number of months.

We conclude that DDTr, a lot of other organic pesticides and other toxic or non-toxic organic chemicals can be removed from the land using accelerated bio-degradation.

The advances of the presented method can be understood by comparison to the list of the most commonly used methods today (Table 1).

TABLE 1
Bioremediation technologies

1. Biodegradation/Biostimulation: Stimulation of indigenous microbial populations in soils or
groundwater; which can be performed either in situ or ex situ.
2. Bioaugmentation: Addition of bacterial cultures to a contaminated medium; frequently used
in bioreactors and ex situ systems.
3. Biofilters: Use of microbial stripping columns to treat (mostly) air emissions or odours
(volatile compounds).
4. Biosparging: The injection of air under pressure can enhance biological degradation; usually
performed in situ; non-invasive.
5. Bioreactors: Biodegradation in a container or reactor; may be used to treat several liquid
wastes or slurries; rapid degradation kinetics but relatively high capital and operational cost.
6. Bioventing: Method of treating contaminated soils by drawing oxygen through the soil to
stimulate microbial growth and activity.
7. Composting: Aerobic, thermophilic treatment process; can be performed by using static piles,
aerated piles, or continuously fed reactors; low cost but extended treatment time.
8. Land farming: Solid-phase treatment system for contaminated soils; may be performed in situ
or in a constructed soil treatment cell; cost-efficient.

During the last two decades a large number of experiments have been performed, where the acceleration of the biodegradation process of complex organic molecules, like the super-stabile DDT and its toxic derivatives DDE and DDD, has been sought-after, as mentioned above.

The long half-lives of stabile chemicals like DDTr, which are often hardly bound to the soil and in this way conserved, are often 10-30 years, making it very important to find a cheap, safe and effective in situ method for land cleaning.

The conclusion of a recent review has been that there are many possible methods for getting rid of chemicals like DDT in soil, but that biodegradation in situ for economical and practical reasons is the only realistic alternative. Methods that work under the relative cold conditions in Sweden were sought after.

We have systematically gone through the literature to identify the key factors that must be controlled in a method that allows for a fast, effective biodegradation of organic molecules in situ.

The most effective of the substrates tested in the experiments is simple warm-composted manure, which most often has been from chicken, cow or horse. The addition of 10% or more of such a substrate to the soil, well mixed in, and adjusted with iron and for pH, is an affordable and sustainable solution to the problem of pollution with organic molecules like DDTr.

As we still become better in controlling the process in situ, we might one day match the lab results, where the half-lives of stable toxic molecules like DDTr's are counted in weeks.

The most interesting thing, that we learn from the literature, is that the combination of the long row of bacteria and fungi we normally find in rich and vital soil adequately stimulated can degrade almost any simple or complex organic molecule, even DDTr and other chloro-organic insecticides—which are amongst the most stable and least bio-accessible molecules known to man.

The presented method thus degrades the organic compounds found in pollution sites—most often large toxic molecules derived from petroleum or natural gas, like polycyclic aromatic hydrocarbons (PAHs), the organochlorine insecticides, organophosphate and carbamate insecticides, organic herbicides. Small molecules like the toxic dioxins etc. can be degraded as well. The broad applicability makes the present method unique.

Globally there is a strong need for methods that can degrade these unwanted substances in the soil, completely and effectively. Without a well-functioning method of in situ biodegradation, there is no realistic, affordable method for clearing the polluted land.

We need a method of biodegradation which is as close to normal land farming as possible, which can be done with the existing farm machines without large new investments, to realistically solve the problem.

The presented method of accelerated biodegradation is exactly that. It is easy; its simple steps can be used by any farmer. Money invested in the clearing of farmland with this method also comes back in the form of increased soil quality because of the added fertilizer that contributes to the soil's content of humus.

The method improves the quality of the soil, making it ready for use after treatment; in many cases—depending on the type of pollutant and the concentration of it—the land will even be useful during the treatment, making the presented method attractive for farmers and investors.

### DESCRIPTION OF THE METHOD OF ACCELERATED BIODEGRADATION OF TOXIC ORGANIC CHEMICALS ACCORDING TO THE INVENTION

The method of accelerated biodegradation is non-specific (unspecific): any organic molecule in the soil is degraded-toxic or non-toxic, complex or simple, contaminant or pollutant. Overall, the environmental risks with the method described herein for remediating contaminated soil in situ have been assessed as negligible.

An example of the applicability is degradation of DDT and its derivatives (DDTr).

DDT might be the single most dominant and threatening pollutant of farmland worldwide. The presented method is useful for everybody who has a farm, nursery, or other piece of land that needs to be cleared of DDT (dichlorodiphenyltrichloroethane) or another organic compound contaminating or polluting your land. It is also useful if you have a mix of compounds, even if the chemical constitution or the combination of compounds is not known.

The method of the present invention can be performed in situ, i.e. in the natural or original location where the contamination or pollution occurred, or alternatively, the method can be performed ex situ, i.e. outside, off site, or away from the natural or original location, for example in a selected land area or in a soil treatment plant.

In the context of the present application the term “soil” refers to the naturally occurring, unconsolidated, upper layer of the ground. Soil may typically comprise, or essentially consist of, organic matter, humus, weathered rock, sand, clay, and/or sludge. The soil to be treated is agricultural soil, horticultural or fruit garden soil, garden soil, building foundation soil, soil along a road with polluting asphalt tar, or forest soil, or soil ex situ elsewhere.

We present the method for biodegradation in situ or ex situ in the followings steps:

### A. Measure and Map the Pollution

Measure the level of contamination/pollution (i.e. DDTr pollution) in relevant different levels of the soil, and with the relevant number of test spots. Compare with the accepted threshold values for the relevant type of pollution, considered the planned use of the land. Then map the area that needs bio-degradation.

The measuring points should ideally be selected based on historic knowledge of the use of the land. After this the measure points must be chosen so closely over the suspected area, that you get a good and realistic picture of the contamination/pollution.

In case of DDT pollution: Measure the DDT, DDD and DDE (or better all the DDTr) concentrations both in top soil (0-30 cm down) and the deep soil (30-100 cm down). You will most likely find that the too high concentrations are only in the top soil.

### B. Analyze how Much Compost/Warm-Composted Manure/Organic Substrate you are Allowed to use on the Land

The next step is to analyze how much fertilizer/compost/warm-composted manure can legally be added to a hectare of farmland, using the numbers for N, P and K for the product, and the numbers for the legal amount given by the local authorities.

The manure used for clearing of fields must always be compost with hard-bound fertilizer, as the nutritions can wash out and pollute the groundwater if they are not hard-bound. We recommend warm-composted manure that will work over a long time period. It keeps N and P quite hardly bound, and releases the nutrients over a 2-3 year-period in the soil. Warm-composted manure thus rarely burns the roots of trees and plants. As the nutrients are released, microorganisms can use them.

Warm-composted manure always has about the same content of nutrients; this means that you can find table values for all the most common products. If you want to use your own compost, which is mixed of a number of different things, this might also work; in this situation you might need to analyze your compost product so you know its precise content of N, P and K. You then need to compare it to warm-composted manure, to be sure that your product has about the same profile of nutrients, so it is useful for the bio-degradation process.

### C. Calculate how Many Square Metres you can Clear in One Go, and Plan the Spots for Treatment

To be sure there is enough organic substrate for the bio-degradation process, you need to add at least 10% (weight per cent) of nutrition-full organic substrate to the soil and mix it in; we recommend the use of 12-15% (weight). If the soil is treated 10 cm down, you are processing 150-160 kg/m2, which takes about 15-20 kg of compost/m2.

Say you are allowed to spread 100 tons of warm-composted horse manure on a hectare in a five-year period, you can treat 100,000 kg/20 kg per m2-5,000 m2 during this period, if you go 10 cm down. You can also treat 2,500 m2 two times, allowing you to clear this land 20 cm down, or you can eliminate pollution completely 30 cm down on 1,667 m2.

It is clear from these calculations that it will take two periods of 5 years to clear the whole one-hectare-field in a 10 cm depth under these circumstances.

It might be possible to get dispensation from the local authorities to use more substrate; or to get permission to spread what you are allowed to use unevenly on your fields, so you can take the manure from the adjacent field and use it on the polluted field.

All this will depend on the understanding and goodwill of the local authorities.

When you know how much land you can treat with the amount of substrate you have available, you can plan precisely what area of your land you want to treat, and when. You will often need a 10-year plan.

### D. Plan how to Avoid to Intoxicate People, Especially Children, and how to Avoid Polluting the Local Environment

The clearing of contamination/pollution must happen in a close dialog with your local environmental authority; this is especially important to prevent accidents and environmental pollution.

When the surface of polluted land is penetrated, we are potentially in a dangerous situation. Now the pollutant is accessible; small children can eat the soil, animals and humans can get intoxicated, and there is a risk for the contaminant spreading to the environment.

If the soil is spread, the pollutant will also be spreading to the sensitive environment. In this situation it is mandatory that the accessibility of the pollution is handled, and the toxic substances are processed right away, in line with what is suggested here.

During all work with the polluted areas, selected for spot treatment, much care must be taken not to spread the pollution. Protect the area from children and the public by fences, and inform the public of the danger with appropriate signs. Lock the gate if necessary.

Another good thing to do is to cover the polluted soil that now lies open, with organic material like straw or better dead leafs from trees, to support the earthworms.

Of course the polluting of ground water and surrounding environment with N, P and K from the manure needs to be carefully avoided; if there is any suspicion of pollution, we recommend test measuring of N and P in the ground water downstream for the treated area.

A simple way to minimize the risk of groundwater and environmental pollution is by “spot-treatment”, so only the most polluted areas are treated with a big amount of manure. If only a part of the pollution is treated each year, this also minimizes the risk of pollution with fertilizer.

It is also important to have sufficient trees or other plants like grass on the land that can use the nutrients, especially the N and P, as they are released from the fertilizer. This is again to avoid the pollution with nitrogen and phosphor.

### E. Treating the Soil With Compost/Warm Composted Manure

Now we can treat the polluted area with the sufficient amount of a slow-degrading organic fertilizer/manure or compost, meaning 10% (weight) or more added to the soil.

Mixing manure into the soil accelerates the biodegradation process, as many studies have shown, but a high concentration of substrate (over 10%) is necessary for the process to run well.

Addition of well-done warm-composted manure to the land is known to take down the pH; it is common procedure to rebalance the pH of the soil with chalk in farming, but chalk (lime, calcium carbonate) should not be added neither to the compost nor to the land during the bio-degradation phase, as fungal degradation of chemicals like DDTr and many other complex organic molecules in general happens faster in an acidic soil (pH=3.0-6.5, with the ideal pH about pH=5.5).

The process is also known to be dependent on accessible iron in the soil; if iron is not present, in a for the process useful chemical form, it must be added to the process together with the manure. Addition of iron, preferably in a quantity of 1-4 kg Fe, Fe²⁺, or Fe³⁺ per ton of applied compost, more preferably in an amount of 1.5-2.5 kg Fe²⁺ iron per ton of compost, most preferably 1.5-2.2 kg Fe²⁺, unless the soil to be treated already comprises at least 2 kg of iron per ton of soil.

The organic substrate must therefore be rich in iron; we prefer to use 1.9 kg metallic powder, Fe, Fe2+ or Fe3+/ton compost, which is the ideal concentration of iron found.

Mix the iron into the compost or spread the manure/compost/substrate on the area you determined, and “pepper” it with the iron salts needed for the biodegradation process. Adjust the plough to 10 cm depth and plough the substrate well into the soil. Make sure that the soil and the compost are well mixed.

It is the combination of the nutritious support of a long row of micro-organisms, both bacteria and fungi, that leads to fast and effective bio-degradation of simple and complex organic molecules.

For bacteria, mushrooms, worms etc. to work on the organic pollutant in the soil, a close contact between soil and substrate seems necessary; every litre of soil must ideally contain about 100-200 grams of the added substrate.

(It is not yet known from the in situ experiments exactly what the best local organization of the soil/substrate mixture is, but from a theoretical position can we give a qualified guess. Fungi, bacteria and other microorganisms benefit from local high concentration of substrate, so an ideal situation is that the soil contains lumps of substrate (manure) of about 0.1-1 dl. You need to try this out and see what works best for you.)

The mixing process can be tricky, as a normal plough is turning the soil but not really mixing it. We therefore strongly recommend that the mixing process is carefully supervised, and that the working of the soil is continued until one reaches the ideal situation described above.

To make sure the mixture of soil and substrate has reached the “processing standard”, one takes a spade and cuts through the soil at random places so the structure is revealed; photographs should be taken to document that the soil and substrate are correctly mixed. Another crucial consideration is that the soil should not be worked too deeply by accident, as a thinning of the substrate concentration in the soil can mean a much longer half-life of the pollutant, as found in studies mentioned above. The control photos of the cut though the prepared field should also show the depth of the processed soil.

We believe that it is wise to start by working only with the top soil; we believe that the best is to process the top 10 cm of the soil only, to begin with. The biodegradation process in the soil can be started well, by growing a large number of worms, finding the correct pH, and getting the optimal concentration of iron in the soil.

A faster decomposition can be obtained by adding more fertilizer to the soil, 10-100% by weight or more.

### F. Cover the Soil With Organic Material Good for Earthworms

After the mixing of soil and substrate with the plough and other appropriate tools, the processing soil is covered with worm-food in the form of organic material like hay, leaves, wood chips, straw and other cellulose material You need to use enough to make sure that the water is not vaporizing from the top soil on a warm or windy summer day. If you use too much top material, you might stop the airflow in and out of the processing soil; which will slow down the bio-degradation substantially.

The rate of biodegradation of pollutants like DDT and its derivatives, and other large organic molecules, are strongly dependent on earthworms, so it is important to increase the number of worms by adding tree leaves or other appropriate organic material.

Make sure the material you use is actually good for worms-fresh straw from corn etc. does not work well; hay is much better. Hay can be pre-composted so the hard surface of the straw is broken. Tree leaves, or black compost soil mixed with grass and other leaves, might be the best to apply.

This gives us a reason to recommend the planting of trees as big as possible on the spot that needs cleaning, as they produce large amounts of leaves that benefit the earthworms.

The biodegradation can be further improved by planting or seeding trees, flowers, grass or the like (phytoremediation). This helps to increase the number and mass of fungi by mycorrhiza (a symbiotic association between a green plant and a fungus) and earthworms, which gives easily accessible channels for plant roots, effective soil drainage and good ventilation to the soil.

Cultured or other microorganisms can additionally be added to the soil (bioaugmentation), to promote the biological breakdown of the polluting substances.

### G. Keeping the Process Going and the Field Wet

Keep the soil wet at all times. But never drown or flood the soil; it needs to be wet but always well drained and not lying on top of it for longer periods. Never block the soil from breathing because you will kill the worms and make the processes anaerobic.

The bio-degradation process of DDT and other organic molecules is highly dependent on water. The amount of water relative to the soil is dependent on the soil type, as sandy soils need more water than clay soils. The concentration of water in the soil should not be too high in heavy soil, as this can block the free diffusion of oxygen into the soil.

Either use a permanent watering system that gives the necessary amount of water (inspect the soil regularly), or use a sensor in the soil that tells you when it is time to water. This needs to be continued for a period of preferably 12 months.

### H. Monitoring and Regulating the pH

The pH must be checked and if necessary regulated down to pH<7, preferably to pH=3-6, more preferably pH=4.5-6.0; for chemicals that need a very low pH; pH=2.0-4.0; for chemicals that need a high pH; pH=7.0-9.0.

In the laboratory the ideal pH for very fast degradation of organic molecules like DDT has been found to be 2-4, but the pH cannot be so low in soil that it kills the earthworms. Meaning the down-adjustment of pH must take the soil type into account and only soil that can support worms well can be radically down-adjusted.

This means that the process will go slower for earth that cannot support worms so well, and therefore many soils need a higher pH (pH=5.0-6.5).

The simplest way to down regulate the pH is by using a mix or normal warm-composted manure and sour compost. The sour compost comes from an—aerobic composting; the air-flow into the compost is regulated during composting till the wanted pH is reached.

Alternatively, can you use chemicals that do not pollute but take the pH down. You add H+ but avoid polluting with negative ions like Cl− and SO4−. The same goes for the Iron salts you add: avoid negative ions that pollute!

There is a special situation, where contaminants or pollutants are stable in an acidic environment; in this case the adjustment of pH of the processed medium is adjusted to pH 7-9, preferably to pH 7.5-8.5, to allow the biodegradation.

### I. Continuing the Process

Measure the soil-concentration of the organic chemical or group of chemicals you want to get rid of, like DDTr, again after one year in the processed soil, to see if the process needs to continue. It is also generally recommended that you measure the content in the layer 10 cm under the processed layer, but this is not strictly necessary as the likelihood for a significant change here is small.

Repeat the soil-cleaning process as many times as necessary. Only go deeper when your top layer is well processed. Remember that half-life of stable molecules like DDT is normally 10-30 years if bound to the soil; be happy if you can break most of the DDTr (or the other organic chemical you want to degrade) down in two-three years. Notice that the process might take a number of years if local factors slow down the process, as mentioned above.

It is important to keep the soil vividly alive, for an effective biodegradation of the organic pollutants.

Go therefore deeper slowly and in appropriate steps, i.e. 10 cm at the time, until you have reached the depth you want to clear.

When you go deeper and want to process the next layer (i.e. the layer 10-20 cm down), it is wise to turn the soil, so you always have the process going in the well-aired top layer of the soil. When you turn the soil, the layer that is 10-20 cm down, comes up and this layer now becomes the top 10 cm layer.

Repeat the process on the layer that is now the top 10 cm of the soil, which was the layer 10-20 cm down before. To get access to the layer 20-30 cm down, you turn the soil 30 cm down the next time, and work the top −10 cm again.

Of course you can also start with the top −15 cm, and turn the soil 30 cm down, when you want to process the layer 15-30 cm down. Or the top 20 cm, and turn the soil 40 cm, to get access to the layer 20-40 cm down. Etc.

What is important to understand is that the process works much better in the top layer than deep down in the soil.

The method can further include analysis of the concentration of one or more contaminating/polluting chemical substances in the soil, before the addition of the fertilizer, and again analysis of the concentration of the substance/substances after predetermined time periods, each predetermined time period preferably being 12 months; and in case the concentration is stable above a predetermined threshold value-repeat the treatment steps for the same soil or material layer until the contaminant/pollutant is degraded to a concentration below said predetermined threshold value.

The method's steps can be repeated for an underlying soil layer below an already treated soil layer. The underlying soil layer, which is now to be treated, is turned up with a plough, so that it becomes the top soil layer, receiving the before said addition of fertilizer, iron and pH-regulator. The soil is turned, preferably in a depth of 20-30 cm, whereby the firstly treated soil layer is moved downward to a position below the soil layer now to be treated; optionally followed by treatment of additional underlying layers by turning soil even deeper, preferably additionally 10-20 cm deeper for each layer, until the concentration of contaminating/polluting compounds in the soil has reached a desired level.

### Practical Notes

Save money by measuring indicators, not the total pollution

If you have a complex pollution you often only need to measure the concentration of a few of the dominant pollutants, as the pollutants are degraded together. This strategy can save the project a lot of money often used for repeated chemical tests of the concentration of dozens of compounds.

Legal limitations for the use of fertilizer and the process time

The most important single factor that limits the time it takes to process the soil with the presented method is the amount of compost/warm composted manure, you can legally add to the soil per year.

In Sweden you are allowed to use 22 kg P/hectare/year which—with 1.6 kg P per tons of warm-composted horse manure with wood chips—corresponds to a total of 69 tons/hectare within each 5-year period.

10% (weight%) organic substrate is a substantial amount, if you think of a 10,000 m2 field with the top 30 cm of the soil polluted (which is often the case). The weight of the soil is 450 kg/m2, or 4.500 tons. 10% of this is 450 tons. If you fertilize with warm-composted horse manure up to the max limit, you are allowed to use the above-mentioned 69 tons/hectare per 5 years in Sweden—given that you have crop on the fields that can use all that the nitrogen (N) as fast as it is released. This will allow you to process 15% of the field in full 30 cm depth, each 5-year period. In this way you can clean your field in 6.5 periods, or 33 years.

Luckily, the situation is normally not that grave. You often only have to clean the top soil, like the upper 10 cm of the soil. This is often the case in DDT pollution, where you need to bring the DDTr concentration down to the threshold value. If you have a DDTr concentration 50% over the threshold limit, you can clean your field in about two periods, meaning 6 years if you move as fast as you can.

In the worst case scenario, where the whole field is highly polluted, the allowed amount of warm-composted manure will limit you to treat 69,000/15 kg per m2=4.600m2 which is only enough for treating half of the most superficial top soil in the field, i.e., the top 10 cm. The next half must wait till the next 5-year period starts. After 10 years half of the deeper layer (10-20 cm down) can be treated (turned with a plough and given the treatment as the layer 10-20 cm down now has become the top layer). And so forth.

This way the complete clearing of DDT of the land will take many years. But then again, that is only the situation, if you want to use the soil for growing potatoes or another harvest that can take the DDT in and give it to the consumers.

If you want to use the field for a sports area and want to have clean soil for your grass lawn, you can process the top 5 cm of the whole field the first year, which is sufficient for having a safe place to play football already next year!

It is important to understand that 69 tons on a hectare of land is a lot of manure. Such an amount can only be used, if there are crops on the field, like big trees, that can use this amount of fertilizer. Alternatively, you are lucky to have a good clay soil that can bind the minerals released from the fertilizer.

Again, the manure must be warm-composted, so the phosphor and nitrogen are strongly bound chemically, and thus not released immediately but over 2-3 years or more—as the case would be with fresh manure.

Fortunately, biodegradation is often, for some reasons we do not understand yet, happening quite effectively in some parts of a field and much slower in another part of the same field. This means that you can treat the “hot spots” with high pollution in a field, and leave the parts with un-critical levels of a pollutant in the same field to the natural degeneration process. Spot-treatment will often allow you to treat spots effectively, and also deeper and deeper every year if that is needed, allowing you to clear the DDTr or another contaminant/pollutant out of a field in only a few years.

1. A method for treating soil in situ or ex situ to reduce the concentration of contaminating or polluting organic chemical compounds in the soil, comprising steps of:
a) determining a contaminated/polluted area where soil is to be treated;
b) adding a fertilizer in the form of warm-composted manure, or other compost having a nutrient content corresponding to warm composted manure and in which the nutrients are correspondingly hard bound to the compost, to a soil layer in the contaminated/polluted area, the fertilizer being added in an amount of 10% (weight percentage) or more of soil of the soil layer;
c) adding iron, unless the soil of the soil layer already comprises at least 2 kg of iron per ton of soil;
d) adjusting soil pH to an acidic pH; and
e) keeping the soil of the soil layer moist by adding water as needed for a predetermined period.

2. The method of claim 1, wherein the fertilizer in the form of warm-composted manure comprises bedding of straw or wood chips, from chicken, cow or horse.

3. The method of claim 1, wherein the contaminated/polluted area is covered with a 1-20 cm thick layer comprising organic material, which is suitable for attracting earthworms.

4. The method of claim 1, wherein the contaminated/polluted area is covered with a 1-20 cm thick layer comprising mulch/wood chips, sawdust or other cellulose containing material that covers the soil of the soil layer and retains moisture without limiting the air exchange, which does not significantly attract earthworms.

5. The method according to claim 1, wherein the fertilizer is added in an amount of 10-100% by weight or more of the soil of the soil layer, in order to allow treatment of soil having a high concentration of contaminating or polluting organic chemical compounds, or to allow faster decomposition.

6. The method according to claim 1, wherein the soil of the soil layer is agricultural soil, horticultural or fruit garden soil, garden soil, building foundation soil, soil along a road with polluting asphalt tar, forest soil, or soil ex situ.

7. The method according to claim 1, wherein the soil of the soil layer consists essentially of sand, gravel, clay, or carbon-based materials.

8. The method according to claim 1, wherein the soil of the soil layer is not a solid substance but a mud or a polluted liquid, that is mixed with manure/compost/fertilizer/bacterial nutrients, and given the addition of iron and the adjustment of the pH, wherein the mud or polluted liquid is added to fresh manure before or while the manure is being warm-composted, whereby the reduction of the concentration of contaminating or polluting organic chemical compounds takes place in solid phase, such that the resulting compost can then be used as normal compost or for further biodegradation, or wherein the polluted mud or liquid is added to a biogas facility in which the biogas-producing liquid is used for cleaning a contaminant or pollutant out of the polluted mud or liquid.

9. The method according to claim 1, further comprising analysing the concentration of one or more contaminating or polluting organic chemical compounds in the soil of the soil layer, before the addition of the fertilizer in step b), and again analysing the concentration of the one or more contaminating or polluting organic chemical compounds after predetermined time periods; and in case the concentration is stable above a predetermined threshold value, repeating the steps b)-e) for the soil of the soil layer until the one or more contaminating or polluting organic chemical compounds is degraded to a concentration below said predetermined threshold value.

10. The method according to claim 1, where the steps b)-e) are repeated for an underlying soil layer below an already treated soil layer, which is now to be treated, turned with a plough so that it becomes the top soil layer to be treated with the addition of fertilizer, iron and pH-regulator, whereby the already treated soil layer is moved downward to a position below the soil layer now to be treated.

11. The method according to claim 1, wherein trees, flowers, or grass are additionally planted or seeded to support the biodegradation by increasing the number of fungi by mycorrhiza and earthworms, which gives easily accessible channels for plant roots, effective soil drainage and good ventilation to the soil of the soil layer.

12. The method according to claim 1, wherein cultured or other microorganisms are additionally added to the soil of the soil layer, thus promoting biological breakdown of the polluting substances.

13. The method according to claim 1, wherein contaminating or polluting organic chemical compounds to be analysed and decomposed comprise a pesticide.

14. The method according to claim 1, wherein contaminating or polluting organic chemical compounds to be analysed and decomposed comprise one or more of gasoline, oil or other polycyclic and aromatic substances from the petrochemical industry.

15. The method according to claim 1, wherein the size of the area to be treated is determined based on one or more of:
a) an assessment of the content of N, P and K in the fertilizer to be used,
b) the amount of fertilizer available, or
c) regulations set by the applicable regulatory authorities regarding the addition of NKP fertilizer to the soil.

16. The method according to claim 1, wherein the adjustment of pH in step e) is replaced with adjustment of the processed medium, to a specific pH, other than the pH mentioned in step e), when this is needed for a specific biodegradation process, to allow biodegradation of contaminants or pollutants that stabilize in an acidic environment.
